(19) United States
(12) Patent Application Publication
(10) Pub. No.: US 2009/0318309 A1
(43) Pub. Date: Dec. 24, 2009

(54) Thermo-reversibly gelled colloidal suspensions and a process for making the same

(76) Inventors: Kyle William Kimble, Inndianapolis, IN (US); Jeremy Paul Walker, Oakmont, PA (US); Sanlord Abraham Asher, Pittsburgh, PA (US)

Correspondence Address: THORP REED & ARMSTRONG, LLP, ONE OXFORD CENTRE, 301 GRANT STREET, 14TH FLOOR, PITTSBURGH, PA, 15219-1425, US

(21) Appl. No.: 12/386,335

(22) Filed: Apr. 16, 2009

Related U.S. Application Data
(60) Provisional application No. 61/124,329, filed on Apr. 16, 2008.

(51) Int. Cl. C40B 40/14; C40B 40/04; B01J 13/00

(52) U.S. Cl. 506/20; 506/15; 516/104

(57) ABSTRACT

Disclosed is a thermoreversible synthesis of a new type of material made by embedding a colloidal population within a thermo-reversibly gelled polymer. The polymer may be a physically cross-linked PVA hydrogel. PVA hydrogels are non-toxic, biocompatible, mechanically robust, and elastic. The present invention TGCCA diffraction is similar to that of photo-polymerized PCCA. The present invention TGCCA can be irreversibly covalently cross-linked using glutaraldehyde. The cross-linked TGCCA can be made responsive to chemical stimuli by functionalizing the hydrogel hydroxyl groups. The diffraction of carboxyl or amine functionalized TGCCA was monitored as a function of the pH and determined diffraction wavelengths titrate with the pKa of the functional group. It was also demonstrated that TGCCA could be fabricated in arbitrarily large volumes and shapes. The present invention method fabricates inexpensive homogenously diffracting chemically modifiable TGCCA.

### CROSS-REFERENCE TO RELATED APPLICATIONS

This application claims priority from U.S. Provisional Application Ser. No. 61/124,329, filed Apr. 16, 2008, and which is expressly incorporated by reference herein.

This invention was made with government support under Contract No. 2ROI EB004132-04A2 awarded by the National Institutes of Health. Therefore, the government has certain rights in the invention.

### FIELD OF THE INVENTION

The present invention generally relates to embedding colloidal particles within a hydrogel composition, and more particularly to embedding an array of colloidal particles within a hydrogel composition that combination resulting in a polymerized crystalline colloidal arrays (“PCCA”). The present invention further relates to methods of making the same. The present invention also relates to sensor materials, optical filter, optical coatings, color shifting additives, paint additives, cosmetics, sound insulation and colloidal storage approaches comprising thermo-reversibly gelled crystalline colloidal arrays (“TGCCA”s), which TGCCAs are made by embedding crystalline colloidal arrays (“CCA”s) within a thermo-reversibly gelled polymer.

### BACKGROUND OF THE INVENTION

A colloid, or colloidal suspension, is a chemical mixture where a first substance is dispersed throughout a second substance. The first substance may be referred to as the particles, as the colloid, or as the colloidal particles. The second substance may be referred to as the dispersant or the solution. Unlike a solution, the first substance is dispersed or suspended in the dispersant and not dissolved. The colloidal particles may remain in a distinct phase compared to the dispersant. Because of this dispersal and the small size of the colloidal particles, colloid suspensions may look like homogeneous solutions. However, a colloidal system consists of two separate phases: a dispersed phase (colloidal particles) and a continuous phase (dispersant).

Colloidal suspensions may be characterized by the composition comprising either the colloidal particles or the dispersant. The colloidal particles are often described based on their size. A population of colloidal particles may be described by the average particle diameter (either number average or weight average), the coefficient of variation in diameter, and the extent of monodispersity (refers to a population of colloidal particles that are distinct and separate contrasted to a population of particles that may be aggregated or agglomerated).

One type of colloidal suspension is called a Crystalline Colloidal Array (CCA). CCA are three-dimensional arrays of monodisperse and monosized particles that self assemble into body-centered cubic (BCC) or face-centered cubic (FCC) lattices and Bragg-diffract light according to the lattice spacing and the refractive index ratio between the spheres and the matrix.

A hydrogel is a solid three-dimensional network which spans a volume of a liquid medium (the term hydro- implying that the liquid is an aqueous solution). This internal network structure may result from physical or chemical bonds, as well as crystallites or other junctions that remain intact within the liquid medium. Two hydrogels familiar to the general population include gelatin dessert (i.e. Jell-O) and soft contact lenses. There are elements of similarity and overlap between the concept of a hydrogel and a colloidal suspension, for example, they may both include two distinct internal phases. However, the two are distinguished herein in that a hydrogel spans the volume of liquid and forms a network which is connected. A colloidal suspension similarly spans the volume of liquid but is made of discrete units which are not connected by physical or chemical bonds. On a very basic level, the distinguishing feature is that colloidal suspensions are typically capable of flowing (i.e. being poured) while hydrogels resist flowing.

When a hydrogel is formed in a colloidal suspension, the colloidal particles may be referred to as embedded within the hydrogel. This approach has been utilized to preserve the CCA ordering, resulting in what is referred to as a polymerized crystalline colloidal array (PCCA). PCCA have been utilized for applications ranging from biosensors to optical filters. PCCA appear brightly colored because the highly charged colloidal particles self-assemble into ordered FCC arrays which Bragg-diffract visible light. The wavelength of the diffracted light depends on the spacing of the FCC crystal lattice. Reference is made to U.S. Pat. Nos. 5,854,078, 6,187,599, 6,544,800, and 7,105,352, which patents are hereby incorporated by reference in their entirety herein, for disclosure related to embedding CCA within hydrogels.

### SUMMARY OF THE INVENTION

Disclosed herein is a colloidal composition that includes a population of substantially monodispersed polymeric colloidal particles embedded, having an average diameter from about 30 nanometers to about 3000 nanometers, within a thermo-reversibly gelled polymer. In illustrative embodiments, the population of substantially monodispersed polymeric colloidal particles has an average diameter from about 50 nanometers to about 800 nanometers.

In one embodiment, the population of substantially monodispersed polymeric colloidal particles has a coefficient of variation of particle diameter of about 25% or less. In another embodiment, the population of substantially monodispersed polymeric colloidal particles has a coefficient of variation of particle diameter of about 10% or less. In another embodiment, the population of substantially monodispersed polymeric colloidal particles may form a crystalline colloidal array. In yet another embodiment, the colloidal composition includes an aqueous solution. In one embodiment, the colloidal composition includes an aqueous solution that has a specific conductance of less than about 1×10⁻⁵ S·m⁻¹. In another embodiment, the colloidal composition includes the aqueous solution includes a co-dispersant. Exemplary co-dispersant include dimethylsulfoxide (DMSO), glycerine, ethylene glycol, propylene glycol and triethylene glycol. In another embodiment, the colloidal composition includes a sugar.

In illustrative embodiments, the thermo-reversibly gelled polymer includes a partially hydrolyzed poly(vinyl) acetate. In one embodiment, the partially hydrolyzed poly(vinyl) acetate is hydrolyzed greater than 80%. In another embodiment, the partially hydrolyzed poly(vinyl) acetate is hydrolyzed greater than 87%. In another embodiment, the thermo-reversibly gelled polymer includes a polymer including the [vinyl alcohol] repeat unit.

A method of embedding a colloidal composition within a thermo-reversibly gelled polymer includes dispersing a population of colloidal particles in an aqueous solution including a polymer and a co-dispersant to form a dispersion and subjecting the dispersion to a temperature which causes the polymer to gel. The method may further include removing ionic species from the dispersion. Exemplary techniques for removing ionic species include adding ion-exchange resin or dialyzing. In an illustrative embodiment, the polymer may include a partially hydrolyzed poly(vinyl) acetate and the co-dispersant may be dimethylsulfoxide, glycerine, ethylene glycol, propylene glycol or triethylene glycol. In one embodiment, the population of colloidal particles includes substantially monodispersed polymeric particles in a crystalline colloidal array having an average diameter from about 30 nanometers to about 3000 nanometers, and a coefficient of variation of particle diameter of about 15% or less. In another embodiment, the temperature which induces gelling in the polymer is less than about 10 degrees Celsius. In another embodiment, the temperature which induces gelling in the polymer is less than about 0 degrees Celsius. In another embodiment, the temperature which induces gelling in the polymer is less than about −20 degrees Celsius.

In illustrative embodiments, a method of storing colloidal particles includes dispersing a population of colloidal particles in an aqueous solution including a polymer and a co-dispersant to form a dispersion, and subjecting the dispersion to a temperature which causes the polymer to gel forming a thermo-reversibly gelled colloidal material. The population of colloidal particles includes substantially monodispersed polymeric particles in a crystalline colloidal array having an average diameter from about 30 nanometers to about 3000 nanometers, and a coefficient of variation of particle diameter of about 15% or less and the thenno-reversibly gelled colloidal material freezes only at temperature of less than about −20 degrees Celsius.

### BRIEF DESCRIPTION OF THE DRAWINGS

For the present disclosure to be easily understood and readily practiced, the present disclosure will now be described for purposes of illustration and not limitation, in connection with the following figures, wherein:

FIG. 1 shows reflectance spectra from each sample of a preferred embodiment of the present invention TGCCA as contained in a conical funnel, glass plates (flats) and round bottom flask;

FIG. 2 shows the impact of cooling a series of preferred embodiment samples, the compositions of which are identified in Table 1, to −20° C. for 3 hours and then allowing them to return to room temperature;

FIG. 3 shows a TEM image of a preferred embodiment of the present invention TGCCA indicating the presence of a 10 nm layer of PVA layer on the particle surface;

FIG. 4 shows the average transmission spectra taken through four locations in both the CCA (black trace) and the TGCCA (red trace) of preferred embodiment samples;

FIG. 5(a) shows a comparison of sixteen transmission spectra taken of a preferred embodiment of the present invention TGCCA to that of sixteen transmission spectra taken of a typically prepared pAMD photopolymerized PCCA. Each spectra coming from a different 9×9 mm area of the PCCA and TGCCA;

FIG. 5(b) shows the average diffraction spectrum and the narrowest (best) diffraction spectrum for both the TGCCA sample and the PCCA sample as used for FIG. 5(a);

FIG. 6(a) shows room temperature diffraction spectra of preferred embodiment samples of the present invention TGCCA crosslinked by 1.5% glutaraldehyde solution after melting PVA physical crosslinks;

FIG. 6(b) shows the diffraction as a function of reaction time for cross-link formation in preferred embodiment samples of the present invention TGCCA crosslinked by 1.5% glutaraldehyde solution;

FIG. 6(c) shows the diffraction as a function of reaction time for cross-link formation in preferred embodiment samples of the present invention TGCCA crosslinked by 0.15% glutaraldehyde solution;

FIG. 7(a) shows the diffraction spectra for a preferred embodiment of the present invention TGCCA functionalized with carboxylic acid groups exhibiting a blue-shift in its diffraction wavelength as the carboxylate is protonated; and

FIG. 7(b) shows the titration curve for a carboxyl and 3-amniophenol functionalized TGCCA preferred embodiment of the present invention.

### DETAILED DESCRIPTION OF THE INVENTION

In the following detailed description, reference is made to the accompanying examples and figures that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed. Additionally, in the following detailed description theory is presented in discussing various concepts of the present invention. Those of ordinary skill in the art will recognize and understand that the theoretical underpinnings described herein may or may not prove accurate and therefore the present invention shall not be limited to circumstances in which the theory proves true by future experimentation.

The following description is, therefore, not to be taken in a limited sense, and the scope of the inventive subject matter is defined by the appended claims and their equivalents.

PVA hydrogels have many properties that make them amenable to applications ranging from paper processing to implantable devices. They are non-toxic, mechanically robust and elastic. PVA is inexpensive, safe, biocompatible and is already used for in vivo applications. Further, PVA hydrogels have recently shown promise for the development of artificial tissues, contact lenses, implanted devices and as vehicles for drug delivery. PVA hydrogels have been made through covalently or physically cross-linking PVA polymer solutions. PVA hydrogels have been covalently cross-linked with dialdehydes, gamma-radiation, or the polymerization of PVA macromers. Physically cross-linked PVA hydrogels have typically been made through the well-known freeze-thaw process. (See Lozinsky V. I.; Galeav I. Y.; Plieva F. M. Trends in Biotechnology, 2003, 21 (10), 445-451).

Hyon et al, describes an alternative method of making physically cross-linked PVA hydrogels through a process that is a derivation from the freeze-thaw process. (See Hyon, S.-H.; Cha, W.-I.; Ikada, Y., Polym. Bull. 1989, 22, 119-122). More specifically, Hyon, et al. describes the preparation of transparent PVA hydrogels from mixed solutions of dimethyl sulfoxide (DMSO) and water without freezing the solvents. Hydrogels made in non-frozen solvent conditions are known in the art as psychrotrophic gels (from psychria meaning chill). These types of hydrogels are formed through the homogeneous formation of nano-crystallites throughout the solution. In the Hyon et al. procedure, PVA was dissolved and poured into a mold at 90° C. and the temperature was lowered to −20° C. Hyon et al. determined that optically clear hydrogels formed at appropriate compositions (PVA concentrations, solvent compositions, and cooling rates) from the cooled liquid.

The psychrotrophic hydrogels developed by Hyon et al. differ substantially from the cryogels made through the freeze-thaw process. More specifically, during the freeze-thaw process, a cryogel forms as the solvent freezes and the PVA is concentrated into the non-frozen regions of the solution. The concentration of PVA in the non frozen regions increases and the PVA crystallizes. The structure of the PVA cryogel is determined by the crystallization of the liquid. The PVA cryogels typically appear turbid because the 3-D crystalline polymer network contains large channels formed by the frozen liquid. In contrast, psychrotrophic gels are formed through spinodal decompositions. The solution is super-saturated due to the low temperature and unfavorable solvent conditions (that is, cononsolvency), and becomes unstable against infinitesimal fluctuations in composition. The nano-crystallites of PVA form as the solution spontaneously separates into two phases.

While PVA is described in great detail, it represents only one of an exemplary category which is suitable for the present invention. In particular, PVA is a species of the genus water-soluble organic polymer that gel in response to changing temperature conditions. Other members of this genus include collagens-derived component, such as gelatin, and polysaccharides, such as dextran. Characteristic of both of the exemplary polymers is that they are charged polymers in an aqueous solution. In one aspect, charged polymers will generally prevent the formation of crystalline colloidal arrays, however, these charged polymers may be useful within the scope of colloidal storage aspects of the present disclosure, where there is no implicit need for non-ionic species.

PVA is also a species within the genus of non-ionic water soluble organic polymers that gel in response to changing temperature conditions. Other species of this genus include uncross-linked, e.g linear or branched, non-ionic copolymers having a polyacrylamide backbone. The acrylamide monomeric units include N-substituent groups capable of hydrogen bonding, and are capable of imparting thermoreversible characteristics to the polymers in which they are incorporated. Examplary polymers include those with a molecular weight of at least about 10 kD, more usually at least about 50 kD, and may be as high as 1000 kD or higher. As used herein, the term acrylamide includes unsubstituted acrylamide and derivatives thereof, such as methacrylamide, and the like, as well as N-substituted derivatives thereof. The weight percent ratio of acrylamide monomeric units of the copolymer comprising N-substituent groups that give rise to the thermoreversible nature of the copolymers to other monomeric units in the copolymer will range from about 15:85 to 99:1, usually from about 55:45 to 95:5, and more usually from about 65:35 to 90:10. One aspect of the present disclosure that distinguishes these polyacryalamides from the prior art is that they are polymers at the time in which they are incorporated with the colloidal particles. The prior art describes methods of incorporating acrylamide monomers into a solution containing colloidal particles and subsequently polymerizing. The present disclosure is distinguished because polymerization does not occur in the presence of the colloidal particles. One aspect of the present disclosure is that there are significant surprisingly beneficial aspects to utilizing polymeric components, as opposed to monomeric components, to form the gel. In particular, the gelling may be induced by a temperature change instead of a reactive pathway, greatly decreasing the complexity of the gelation and enabling morphological variations not possible with the monomeric techniques of the prior art.

There is a need in the art for a hydrogel with an embedded crystalline colloidal array and a method of making the same that is optically similar to photo-polymerized PCCA and is thermally stabilized, but which hydrogel can be melted by increasing the temperature. There is a need in the art for a hydrogel with an embedded crystalline colloidal array wherein the hydrogel can be removed leaving a secondary material as the basis for the new crystalline colloidal array. The secondary polymer can be any number of polymer systems including but not limited to ionic polymers, non-ionic polymers, biopolymers, proteins or inorganic materials.

One aspect of the present disclosure is that the approach of combining thermo-reversible gelation and colloidal particles is not limited to the temperature conditions, hydrogels, and colloids which may be suitable for TGCCA; but rather, disclosed is an approach for the storage of colloidal particles which is independent from the formations of any array.

In researching the area of hydrogels suitable for the preparation of polymeric crystalline colloidal arrays; suprisingly, a novel method for storing particles was developed. A process for storing colloidal particles includes the following, dispersing a population of colloidal particles in a dispersant, dissolving a polymeric composition in that dispersant to form a mixture, lowering the temperature of that mixture so that the polymer undergoes thermo-reversible gelation to form a hydrogel-suspended colloidal composition. In one embodiment, the process further includes raising the temperature of the hydrogel-suspended colloidal composition so that the thermo-reversible process reverses and the hydrogel-suspended colloidal composition becomes a liquid mixture including the polymer, the population of the colloidal particles, and a dispersant.

In illustrative embodiments, the population of colloidal particles may be substantially monodispersed colloidal particles. As used here, monodispersed refers to a population of colloidal particles that are distinct and separate contrasted to a population of particles that may be aggregated or agglomerated. Aggregated and agglomerated particles are characterized by multiple colloidal particles being in constant contact with each other, such as to form an aggregate which is a single unit of two or more colloidal particles. One aspect of the disclosure is that aggregation and agglomeration are detrimental to the value of a population of colloidal particles while the particles are being stored. In fact, many applications of colloidal particles are intended to examine the controlled aggregation or agglomeration of colloidal populations in response to a stimulus.

In one embodiment, the population of colloidal particle comprises a population of polymeric colloidal particles. In another embodiment, the population of colloidal particle comprises a population of polymeric colloidal particles having a average colloidal particle diameter of between 50 and 1500 nanometers.

PCCAs are oftentimes developed using a photo-polymerization process. However, there are certain disadvantages inherent with this process. First, the thickness attainable through UV photo-polymerization is limited by the optical density of the PCCA precursor solution. Particles which strongly scatter or absorb UV light prevent initiation of the free-radical polymerization deep within the hydrogel. Additionally, photo-chemically unstable molecules cannot be incorporated within the PCCA during synthesis. Further, photo-polymerization requires that specialized quartz containers, reactants and polymerization chambers be utilized. Therefore, there is a need in the art for a new product and process that does not have these disadvantages.

Electrical conductivity of water samples is used as an indicator of how salt-free, ion-free, or impurity-free the sample is; the purer the water, the lower the conductivity (the higher the resistivity). Conductivity measurements in water are often reported as “Specific Conductance”, which is the conductivity of the water were it measured at 25° C.

Preparation of a preferred embodiment of the present invention PCCA. A preferred embodiment of the present invention is prepared by mixing a solution of poly(vinyl alcohol) (PVA) (Polysciences, 98 mole % hydrolyzed, MW ˜78,000) 5% (w/w) in dimethylsulfoxide (DMSO, Fisher) with the crystalline colloidal array (CCA) solution. The CCA solution contains monodisperse cross-linked polystyrene colloidal particles (110 nm, 10% w/w in water). After adding the PVA solution to the CCA solution, ion exchange resin (Bio-Rad AG 501-X8 (D) Resin) is added and the mixture is agitated until strong diffraction is visually evident (2 min.). The ion-exchange resin is removed from the solution through centrifugation and the TGCCA precursor solution is poured or injected into a cell and the temperature lowered. After 2 hours, at −20° C., the solvent remains unfrozen, but the TGCCA has gelled and can be removed from the cell.

Those of ordinary skill in the art will recognize that while PVA was used in the preferred embodiment described above, it may be possible to utilize a wide variety of thermo-reversible polymers and therefore the present invention should not be limited to PVA. Additionally, PVA is made from poly-vinyl acetate and depending on how it hydrolyzed different types of PVA are made and may be utilized. Therefore the term PVA as used herein shall mean and encompass all different types of PVA. Further, PVA is unique because it is non-ionic, however, it is contemplated that the present invention also encompasses PVA grafted onto other polymers. Additionally, those of ordinary skill in the art will recognize that the ion exchange resin described above may not be required in systems that are non-ionic, and therefore, such systems are also covered by the present invention. Additionally, those of ordinary skill in the art will recognize alternative methods for removing ionic impurities from a solution, such as dialysis, may be used, and therefore these other methods are also covered by the present invention.

A sample of a preferred embodiment of the present invention was made by placing a 0.5 ml drop of the TGCCA precursor solution between two square glass plates separated by a 100 m polyester spacer. When the plates were forced together, the precursor solution spreads evenly throughout the cell and the excess solution was forced from the cell edges. The cell was divided into sixteen 9 mm square regions that were analyzed via UV-Vis transmission spectroscopy with a 5 mm diameter aperture. The results of the analysis is discussed in detail below in connection with FIG. 1.

The glass and quartz plates were cleaned prior to use by soaking in 1M NaOH (Fisher), with subsequent rinsing with water, acetone (EM Science), and methanol (EM Science). After drying in an oven at 140° C., SigmaCote (Sigma) was pipetted onto the warm surface and allowed to evaporate. SigmaCote is a solution of a chlorinated organopolysiloxane in heptane which reacts with surface silanol groups on glass to produce a neutral, hydrophobic, microscopically thin film. The glassware was placed in the oven at 140° C. for 20 minutes and, after cooling, rinsed with methanol.

The feasibility of preparing thick TGCCA is shown in FIG. 1. A conical funnel, glass plates and a round bottom flask each containing a sample of a preferred embodiment of the present invention TGCCA were prepared. Each sample has a volume of 50 ml and is approximately 100-fold larger then typically prepared PCCA (0.5 ml). FIG. 1 shows reflectance spectra from each sample of a preferred embodiment of the present invention TGCCA as contained in a conical funnel, glass plates (flats) and round bottom flask.

Diffraction and Transmission Measurements. The backscattered diffraction from the TGCCA samples as identified above was monitored using a fiber-optic diode spectrometer with a tungsten halogen light source (Ocean Optics) and a reflectance probe. The diffraction spectra as shown in FIG. 1 were measured by contacting the fiber optic probe against the glass wall. The samples' iridescence results from the back-diffraction of light by the FCC crystal lattice of the embedded CCA. The relationship between the diffracted wavelength of light (λ₀) and the lattice spacing closely follows Bragg's law:

λ₀=2nd sin θ

Back-diffracted light normal to the PCCA surface was utilized to characterize the lattice spacing and the volume of the hydrogel. The diffracted wavelength in air, depends on the diffracting plane spacing, d, and the refractive index of the system, n. The reflectance from the PCCA is observed normal to the surface (θ=90°).

The UV-VIS transmission spectra as shown in FIG. 1 were measured by a Varian Cary 5000 UV-Vis spectrophotometer. Only planar samples with thicknesses of less than 300 m were measured while contained within the glass or quartz plates in which they were prepared. Samples were measured within 1 day of preparation. Locations on the samples were labeled on a grid pattern. Each region of the grid was analyzed independently utilizing a 5 mm round aperture. The spectrometer was run in dual beam mode. The reference beam passed through a cell prepared in an identical manner to those utilized for the TGCCA of the present invention, but filled with 18M water.

FIG. 1 shows the characteristic back diffraction spectra of the TGCCA. The diffracted wavelength of each TGCCA differs because they were prepared at different colloid concentrations. The lattice spacing and consequently the diffraction wavelength may be controlled by the concentration of the colloidal particles. It will be readily understood to those skilled in the art that the diffracted wavelength can span the entire visible spectrum.

Transmission Electron Microscopy of PVA layer. A 6% solution of 180 nm colloidal particles was mixed with a 5% solution of 78,000 MW PVA in DMSO. The solution was mixed by turning it end-over-end for two hours. A drop of the solution was diluted to 3 mL in a 50% DMSO and water solution and dried on a 75 mesh 3.0 mm O.D. copper TEM grid (Ted Pella). The sample was placed in a vacuum oven at 40° C. for 2 hours under reduced pressure. The micrograph was taken with a Jeol JEM-1400 using an accelerating voltage of 80 kV and a magnification of 180,000.

Testing Thermal Reversibility. A TGCCA preferred embodiment sample of the present invention was fabricated between a set of cleaned glass plates (6 cm×6 cm). A 5 mm wide polyester film space (˜100 μm thick, Grafix, Inc.) was cut so as to contain a 36 mm×36 mm×36 mm×100 μm PCCA. This spacer was placed between the plates to provide a uniform TGCCA thickness and to separate the TGCCA precursor solution from the adhesive used to seal the edge of the cell (Instant Crazy Glue, Elmer). The TGCCA precursor was placed in the cell and the cell was closed. Excess precursor solution was drawn out of the spacer region by utilizing Kim-Wipe. After the spacer region had dried, adhesive was added to the edge of the cell and capillary action drew the adhesive into the spacer region. After the adhesive had set, the cell was placed at −20° C. for 2 hours to gel the sample. The gel was then placed in an oven at 85° C. for 30 minutes to cause the TGCCA to melt. Melting was confirmed by movement of an air bubble trapped in the cell.

Formation of Covalent Cross-links. A 40 mL solution of 50% DMSO and water was added to a 125 ML Nalgene straight-sided wide mouth jar. 0.6 ml glutaraldehyde solution (Sigma, Grade 11, 25%) and 0.4 ml of concentrated sulfuric acid (J.T. Baker) were then added. A 3 cm×3 cm (250 μm thick) TGCCA sample was cut into 16 pieces with a razor blade and placed in the Nalgene jar. To quench the reaction, TGCCA pieces were removed and immersed in gently stirred pure water. The bath water was replaced after 5 min.

Conjugation of Carboxylic Acid. A covalently cross-linked TGCCA was exchanged from pure water to pure DMSO through a gradient with steps at 25%, 50%, 75% and 100% DMSO. After 2 hours in each solution, the TGCCA was transferred into the more concentrated DMSO solution. The 100% DMSO solution (200 mL) was replaced 3 times, with 2 hours equilibration times. The TGCCA was placed into a 40 ml solution of DMSO containing 0.22 g of succinic anhydride (Sigma). The reaction was allowed to proceed for 2 hours at room temperature prior to rinsing with DMSO. The TGCCA was then solvent exchanged through the DMSO/water gradient to pure water. Diffraction spectra were taken with a reflectance probe as the carboxylated TGCCA was titrated with 20 mM HCl (Fisher) solution in the presence of 150 mM NaCl. The 20 mM HCL solution was added drop-wise. The pH of the solution was monitored as acid was added. After each addition of acid, the TGCCA was allowed to equilibrate, a spectrum was taken, and the pH recorded.

Conjugation of 3-aminophenol. 0.5 g of 3-aminophenol (3-AMP, 4.6 mmol, Sigma) was dissolved in 10 ml of DMSO (J. T. Baker) and then diluted to 50 ml with 50 mM phosphate buffer solution (PBS, Pierce Biotechnology). The TGCCA was incubated for 4 hours in the 3-AMP hydrochloride (EDC, 0.52 mmol, Pierce Biotechnology) was dissolved into the solution containing the TGCCA and the reaction was allowed to proceed for 2 hours. The 3-AMP functionalized PCCA was rinsed repeatedly with a 150 mM NaCl (J. T. Baker) solution and titrated as above except utilizing 20 mM NaOH (Fisher).

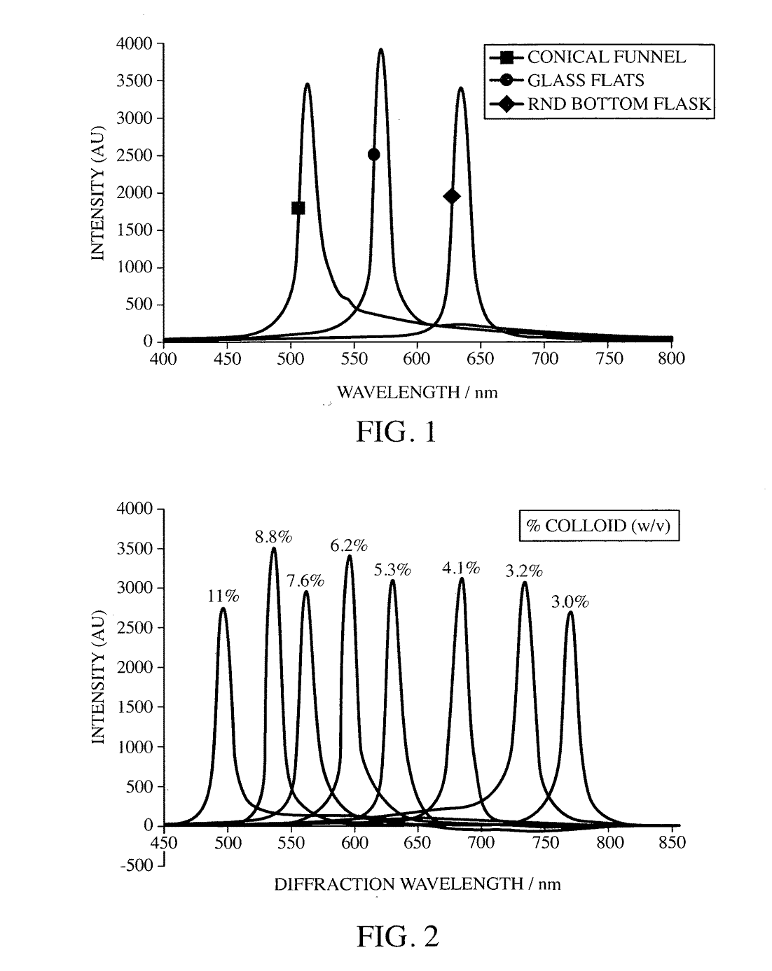

DMSO May Enable the Embedding of Colloidal Particles. The role of each component within the present invention TGCCA precursor solution was examined by thermally cycling compositions which lacked one or more of the components necessary for fabricating a TGCCA of the present invention. The following table describes the composition of the samples shown in FIG. 2.

TABLE 1
Samples in FIG. 2 made with different compositions

| | a | b | c | d | e | f |
|---|---|---|---|---|---|---|
| PVA | 5.00% | 5.00% | 5.00% | 5.00% | 0 | 0 |
| Colloid | 0 | 0 | 7.50% | 7.50% | 7.50% | 7.50% |
| Water | 95.00% | 42.50% | 87.50% | 43.80% | 92.50% | 46.30% |
| DMSO | 0 | 42.50% | 0 | 43.80% | 0 | 46.30% |

FIG. 2 shows the impact of cooling a series of preferred embodiment samples, the compositions of which are identified in Table 1, to −20° C. for 3 hours and then allowing them to return to room temperature. After thermal cycling, sample a was a liquid, while sample b was gelled. Sample a, which consisted of PVA dissolved in pure water, was subjected to five additional thermal cycles. At −20° C., sample a appeared frozen; when inverted, the sample did not flow. Furthermore, the surface of sample a was corrugated and air bubbles were dispersed throughout the sample. Upon returning to room temperature, sample a returned to the liquid state. Over the course of six additional thermal cycles, sample a became more viscous until it gelled and became infinitely viscous after the sixth cycle. Sample b, which was a PVA dissolved in DMSO and water, gelled after a single cooling cycle.

Samples c and d were identical to samples a and b respectively, except that they additionally contained colloidal particles. Before being cooled to −20° C., both samples c and d ordered into a CCA and strongly diffracted light. Sample c, made without DMSO, exhibited no diffraction after being cooled to −20° C. Like sample a, sample c appeared frozen at −20° C. with ice protruding from the surface. Unlike sample a, sample c gelled after a single thermal cycle. Sample d, made with DMSO, water, colloidal particles and PVA, gelled to form a strongly diffracting TGCCA after a single cooling cycle.

Both samples e and f were colloidal suspensions containing no PVA. While both CCA initially diffracted light, sample e froze at −20° C. and the diffraction disappeared. After returning to room temperature, sample e melted and the colloidal particles appeared to be aggregated, with much precipitate. At −20° C., sample f remained an unfrozen CCA. Upon returning to room temperature, sample f continued to diffract similarly to that prior to the temperature decrease.

Samples a and b demonstrate two different mechanisms of PVA gelation. Without DMSO, the solution freezes and the hydrogel that forms is called a cryogel or a freeze-thaw gel. Samples e and f were included to demonstrate the affect of solvent freezing on CCA ordering. Freezing causes the particles to aggregate extensively and become disordered presumably due to exclusion of the particles to the interfaces between frozen crystallites. DMSO depresses the freezing point of the solution below −20° C. and CCA remains ordered (sample f). Sample c, made without DMSO, froze during the thermal cycling. The presence of the PVA did not prevent the CCA from disordering upon solvent freezing. Sample d forms an ordered TGCCA because the DMSO depresses the freezing point of the solution and causes the PVA to gel.

The PVA phase diagram depends on the concentration of both the water and DMSO. A critical aspect of the gelation is the cononsolvency of PVA in a solution of DMSO and water. Cononsolvency describes the phase behavior where PVA is soluble in both water and DMSO individually but crystallizes out of water-DMSO mixtures. Cononsolvency is observed because water and DMSO interact strongly to form stable DMSO-hydrates. PVA interacts less favorably with DMSO-hydrates than with either water or DMSO. Therefore, PVA extensively forms inter-chain hydrogen bonds in a solution of DMSO-hydrates. This inter-chain hydrogen bonding leads to the formation of nano-crystallites. The formation of nano-crystallites occurs quickly at −20° C., but more slowly at room temperature. The turbidity of the hydrogel depends on the size of the crystallites formed.

The cononsolvency effect is strongest when the solution is ˜60% (w/w) DMSO (mole ratio of water to DMSO is 2.5-2.9). Thus, the solvent composition that is used to form a preferred embodiment of the present invention TGCCA is slightly water-rich (50% DMSO). At this composition, all DMSO is fully hydrated and additional free water is present in solution. With additional free water present, the PVA crystallization depends on the solution temperature. The gel phase occurs when the nano-crystallites become effective cross-links between polymer chains. Initially, inter-chain hydrogen bonding dominates the crystallite formation. Water-rich or DMSO -rich solutions crystallize more slowly; free water or free DMSO inhibit crystallization by interacting with the PVA hydrogels and preventing inter-chain hydrogen bonding.

The properties of the present invention TGCCA depend on the concentration of colloidal particles. It was determined that hydrogels made without embedded colloidal particles gel more slowly than the present invention TGCCA hydrogels. A TG hydrogel made without an embedded array of colloidal particles took 12 times longer to solidify compared to similarly prepared TGCCA of the present invention. These results are shown below in Table 2. This is the opposite behavior compared to UV photo-polymerized hydrogels. Without colloidal particles, photo-polymerized hydrogels polymerize more quickly because the light is not absorbed by the particle.

TABLE 2
The presence of the embedded array of colloidal
particles increases the rate of gelation.

| Time (hr) | TGCCA | TG |
|---|---|---|
| 2 | Gel | Viscous solution |
| 4 | Gel | Viscous solution |
| 8 | Gel | Viscous solution |
| 24 | Gel | Viscous solution |
| 48 | Gel | Gel |

Furthermore, the present invention allows for the synthesis of TGCCA at lower PVA concentrations in the presence of colloidal particles. A preferred embodiment TGCCA was synthesized with 2% PVA While a TG hydrogel without embedded particles could not be made at this PVA concentration using a single thermal cycle. Not only did the presence of colloidal particles increase the rate of gelation, but they also made the hydrogel more robust. Hydrogels formed without embedded colloidal particles swelled more upon exposure to water, and dissolved more quickly in a hot water bath than TGCCA.

Additionally, it appears that the presence of colloidal particles significantly alter the distribution of PVA in solution. More specifically, TEM was used to examine whether PVA adsorbed onto the colloidal particles. A small quantity of the present invention TGCCA precursor solution was removed, prior to gelation, and diluted into a 50% solution of DMSO and water (same DMSO:H₂O ratio as the precursor solution). After depositing a drop of this solution onto a TEM grid and drying in a vacuum oven, TEM was utilized to image the particles.

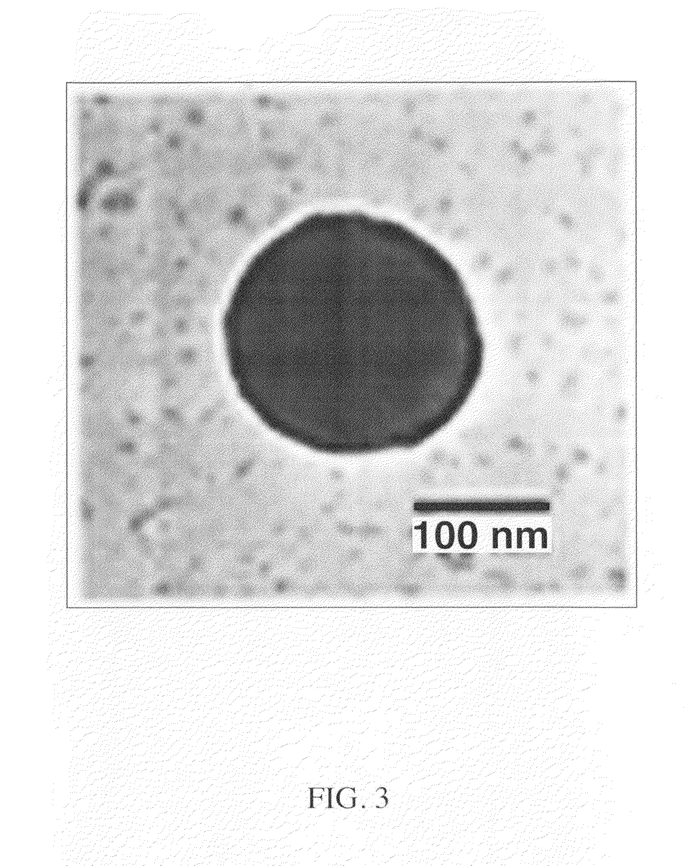

FIG. 3 shows a TEM image indicating the presence of ˜10 nm layer of PVA layer on the particle surface. A sphere without PVA on the surface would have a smooth surface and would not exhibit the electron density increase at the particle edge. Of course, those of ordinary skill in the art will recognize and understand that the present invention is not limited to those materials which, when dried, result in a 10 nm layer of PVA absorbed to the surface.

The thickness of a PVA layer adsorbed onto a polystyrene colloidal particle depends on the properties of the solution, the concentration of the PVA, the temperature and the nature of the particles (size, composition, cross-linking, surface charge, and even the prevalent counterion). The layer thickness observed correlates well with Van de Ven's measurement of the increase in particle radius due to the adsorption of PVA onto polystyrene colloidal particles (5-20 nm) determined utilizing dynamic light scattering. The adsorption causes the concentration of PVA in the vicinity of the particle surface to be higher than it is in the solution. This increased concentration in the vicinity of the colloidal particle may facilitate the formation of nano-crystallites of PVA.

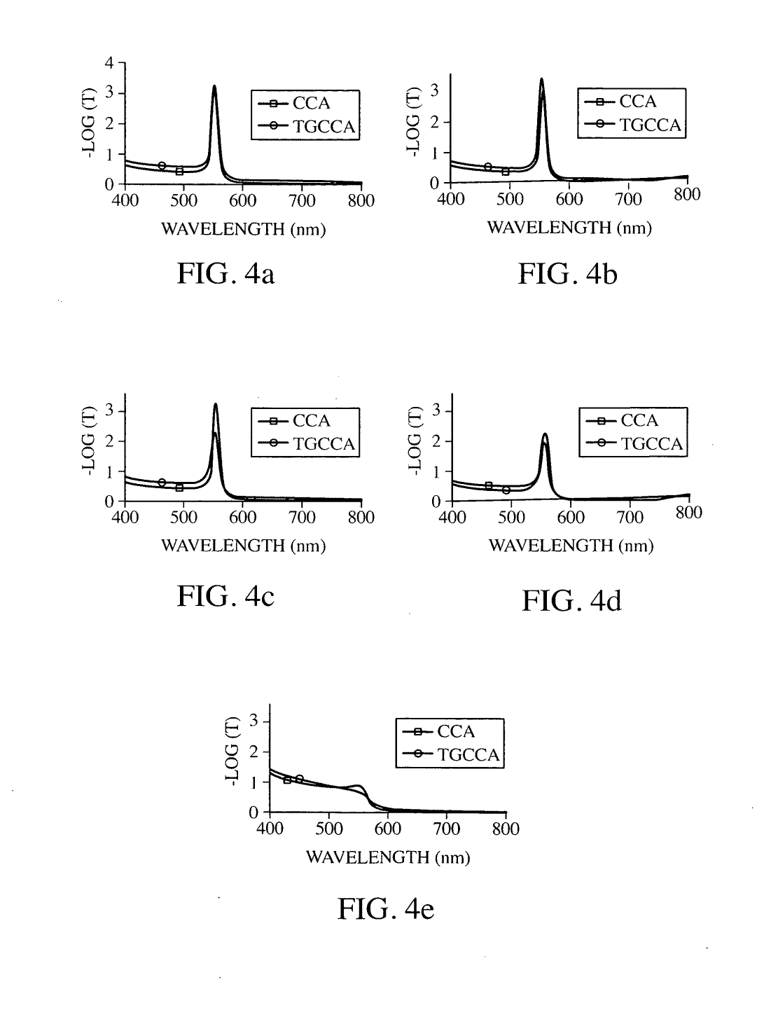

Thermal Reversibility. The impact of thermal cycling on the diffraction of light by the TGCCA of the present invention was studied and is shown in FIG. 4. The sample consisted of 3% PVA in a solution of 50% DMSO and water with approximately 5% colloidal particles by volume. 0.5 mL of the solution was placed onto a glass plate inside a polyester spacer. Another glass plate sandwiched the sample and squeezed excess solution out of the spacer edges. The transmission of light through the sample was measured to probe ordering of the CCA in both the liquid and the gel phase. The sample was first placed in a −20° C. bath for 2 hours, which caused the CCA to gel and form a TGCCA. After the sample returned to room temperature, spectra was acquired. The sample was then subjected to 85° C. for 30 minutes, causing the TGCCA to melt into a CCA. After returning to room temperature, additional spectra was acquired. The spectra from five thermal cyclings are shown in FIG. 4.

Initially, the diffraction spectra did not change as the CCA gelled into TGCCA. In FIG. 4 row 1, the black and red traces are nearly identical. This is consistent with the similarities seen visually between the CCA and TGCCA samples at that time. After heating to 85° C., the CCA and the TGCCA spectra are still very similar and the samples were also visually very similar.

Upon cooling the sample and forming a TGCCA for the second time, disorder becomes evident in the lower left hand corner of the sample. Heating the sample causes the gel to melt and the size of the disordered regions increase within the sample and around the edges. Upon cooling the sample to reform the TGCCA, the lower left portion of the sample becomes increasingly disordered and the diffraction peak height decreases. The sample becomes increasingly disordered with additional thermal cycling until only small regions within the sample diffract.

FIG. 4 shows that the sample can be thermally cycled between the liquid and solid state, but multiple cycles negatively impact the diffraction. The diffraction decreases at the edge of the cell. This may suggest that the leaching of ionic impurities from the vicinity of the spacer and adhesive is responsible for the disorder.

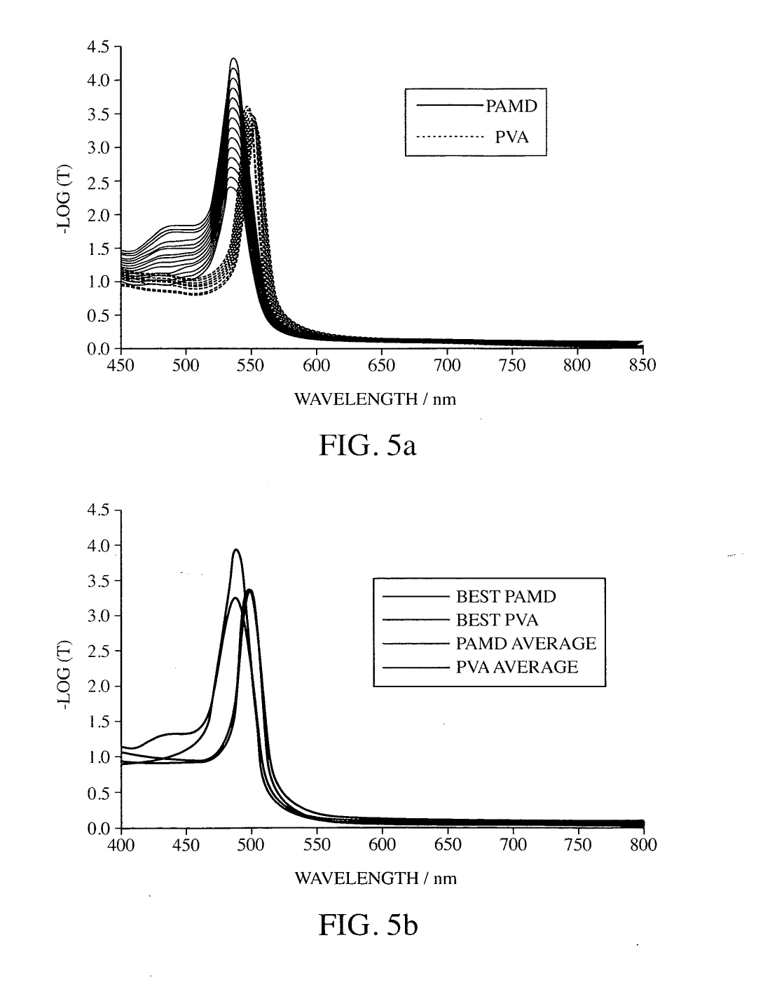

Comparison of Ordering between TGCCA of the present invention and Photo-polymerized PAMD PCCA. FIG. 5(a) compares the transmission spectra of a TGCCA to that of a typically prepared pAMD photo-polymerized PCCA; each gel was 100 μm thick and made with the same 110 nm diameter colloidal particle. Both the TGCCA and the photo-polymerized PCCA were made by injecting the respective precursor CCA solutions between quartz plates separated by a 100 μm parafilm spacer. The TGCCA's diffraction peak (FWHM) was narrower at 17 nm compared to the 25 nm for the photo-polymerized pAMD PCCA. The standard deviation of the TGCCA diffraction peak maxima was found to be σ=1.8 nm and the standard deviation of the photo-polymerized sample was found to be σ=3.0 nm. The FWHM (bandwith) expected for a CCA made from 110 nm is expected to be approximately 14 nm according to dynamical Bragg diffraction theory, thus both the TGCCA and the PCCA are larger than expected.

FIG. 5(b) shows the average diffraction spectrum and the narrowest single diffraction spectra for both the PVA TGCCA of the present invention and the photo-polymerized pAMD PCCA. The PCCA shows much more variability in diffraction between different regions. The best PCCA region shows a much higher diffraction than the present invention TGCCA. However, the poorer PCCA regions displaying a diffraction shoulder. A perfect FCC lattice, where 111 planes were oriented perpendicular to the incident light, would show no diffraction until approximately half the wavelength of light diffracted by the 111 planes (˜250 nm). Thus, both the PCCA and the TGCCA are imperfect CCA. The overall narrower diffraction bandwith of the TGCCA of the present invention indicates superior ordering.

Cross-linking the Hydrogel. Thermo-reversible gelation results in PVA nano-crystallite physical cross-links that melt at higher temperatures. To create a covalently cross-linked hydrogel, glutaraldehyde was used to cross-link the PVA hydroxyls. Two different concentrations of cross-linking reagents were explored and the impact of different cross-link concentrations was monitored by removing pieces of the sample at different reaction times and transferring them into pure water. The samples were then heated to 85° C. for 30 minutes.

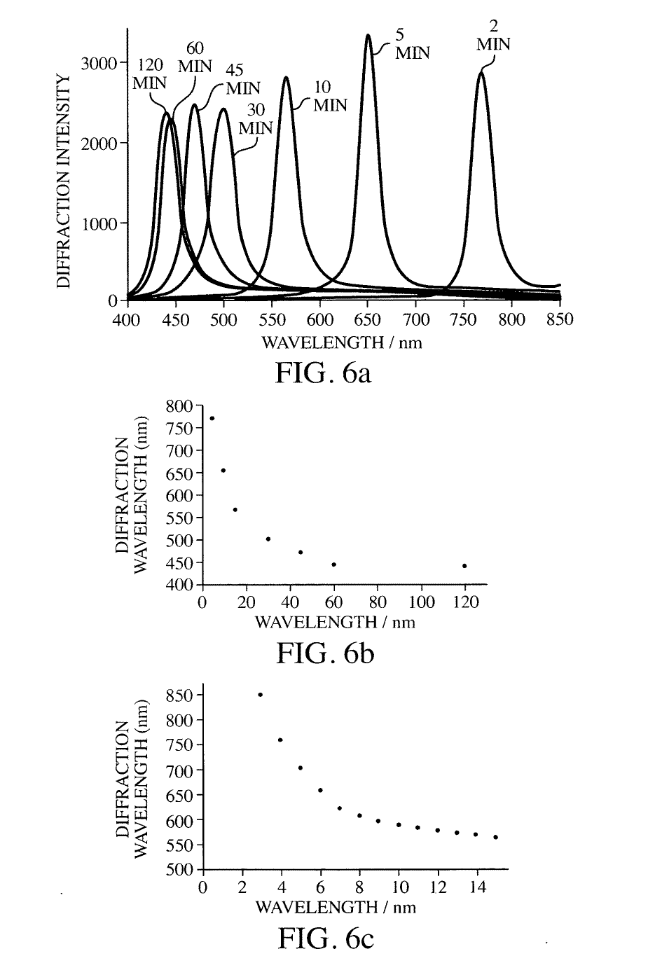

PVA TGCCA without covalent cross-links of the present invention dissolve very rapidly at 85° C. because the nano-crystallites which physically cross link the hydrogel melt and dissolve. The cross-link density determines the equilibrium hydrogel volume, which was monitored by measuring the wavelength of the diffracted light as is shown in FIGS. 6(a), (b) and (c).

FIG. 6(a) shows the diffraction spectra from samples removed at different times from a 1.5% glutaraldehyde dross-linking solution. FIG. 6(b) and FIG. 6(c) show the diffraction as a function of reaction time for cross-link formation in 1.5% and 0.15% glutaraldehyde solutions. With 1.5% glutaraldehyde, the cross-linking reaction occurs quickly and 2 minutes was sufficient to form a stable hydrogel, which did not dissolve upon heating. After 60 minutes, the 1.5% glutaraldehyde dross-linked hydrogel no longer blue-shifts. This may indicate that the 50-fold excess of glutaraldehyde has cross-linked every PVA hydroxyl group after ˜60 minutes for the 1.5% glutaraldehyde solution.

A thermally stable hydrogel formed in 3 hours with 0.15% glutaraldehyde. As with the higher concentration of glutaraldehyde, the diffraction wavelength blue-shifts with increasing reaction times; however, the cross-linking reaction is slower (as shown by the abscissa is in units of hours).

Functionalization of the Hydrogel. A TGCCA chemical sensor may be prepared by attaching chemical recognition groups to the hydrogel. A 3 cm×3 cm×100 μm TGCCA of the present invention was covalently cross-linked by using a 0.15% glutaraldehyde solution as described above. Succinic anhydride was reacted with the PVA hydroxyls to functionalize the TGCCA with carboxylates. These pendant carboxylic acids make the TGCCA sensitive to pH. The carboxylated TGCCA was further modified with amines using carbodiimide chemistry to link 3-AMP to the carboxylates.

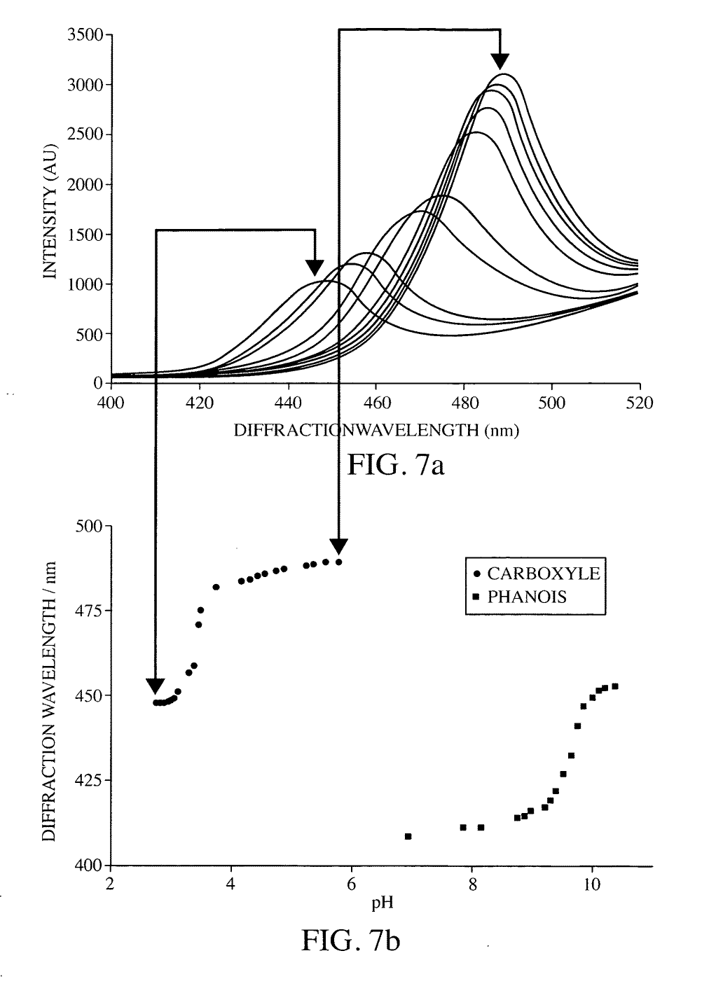

FIGS. 7(a) and (b) show the diffraction spectra and the titration behavior, respectively, for carboxylated and aminated TGCCA. The TGCCA shows a peak maximum ˜490 nm at neutral pH and blueshifts to 445 nm as the pH decreases to pH+3. The midpoint of the titration curve indicates an effective TGCCA carboxylate pKa ˜3.5. For the amine coupled TGCCA we see a similar titration curve but with a pKa ˜9.6. In the absence of TGCCA functionalization little pH dependence of the diffraction was observed.

Storage of particles embedded in a thermoreversibly gelled polymer. A preferred embodiment of the present invention is prepared by adding a solution of gelatin (Sigma, from cold water fish skin 45% w/w in water) with colloidal particles at a ratio of 1:9 resulting in a solution containing 4.5% w/w gelatin. The colloidal particle solution contains polymeric colloidal particles (220 nm, 30% w/w in water). After adding the gelatin solution to the colloidal particle solution, the temperature lowered. After 3 hours, at 4° C., the solvent remains unfrozen, but the polymer has gelled and particles are embedded. The particles may then be stored indefinitely without the risk of particle aggregation. Heating the polymer solution to 90° C. for 1 hour results in the polymer being melted and the polymer may be removed from the composition through dialysis or cross-flow filtration.

Another embodiment of the present invention is prepared by adding a solution of gelatin (Sigma, from cold water fish skin 45% w/w in water) with colloidal particles at a ratio of 1:9 resulting in a solution containing 4.5% w/w gelatin and adding 10% w/w ethylene glycol. The colloidal particle solution contains polymeric colloidal particles (220 nm, 30% w/w in water). After adding the gelatin solution to the colloidal particle solution, the temperature lowered. After 3 hours, at −10° C., the solvent remains unfrozen, but the polymer has gelled and particles are embedded. The particles may then be stored indefinitely without the risk of particle aggregation. Heating the polymer solution to 90° C. for 1 hour results in the polymer being melted and the polymer may be removed from the composition through dialysis or cross-flow filtration.

All of the references cited herein are incorporated by reference in their entirety.

It is emphasized that the Abstract is provided to comply with 37 C.F.R..sctn. 1.72(b) requiring an Abstract that will allow the reader to quickly ascertain the nature and gist of the technical disclosure. It is submitted with the understanding that it will not be used to interpret or limit the scope or meaning of the claims.

In the foregoing Detailed Description, various features are grouped together in a single embodiment to streamline the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of this invention may be made without departing from the principles and scope of the invention as expressed in the subjoined claims.

1. A colloidal composition comprising a population of substantially monodispersed polymeric colloidal particles embedded within a thermo-reversibly gelled polymer, wherein the population of substantially monodispersed polymeric colloidal particles has an average diameter from about 30 nanometers to about 3000 nanometers.

2. The colloidal composition of claim 1, wherein the population of substantially monodispersed polymeric colloidal particles has a coefficient of variation of particle diameter of about 25% or less.

3. The colloidal composition of claim 2, wherein the population of substantially monodispersed polymeric colloidal particles has a coefficient of variation of particle diameter of about 10% or less.

4. The colloidal composition of claim 2, wherein the population of substantially monodispersed polymeric colloidal particles are forming a crystalline colloidal array.

5. The colloidal composition of claim 1, further comprising an aqueous solution.

6. The colloidal composition of claim 5, wherein the aqueous solution has a specific conductance of less than about 1×10⁻⁵ S·m⁻¹.

7. The colloidal composition of claim 5, wherein the aqueous solution includes a co-dispersant.

8. The colloidal composition of claim 7, wherein the co-dispersant is selected from the group consisting of dimethylsulfoxide, glycerine, ethylene glycol, propylene glycol and triethylene glycol.

9. The colloidal composition of claim 5, wherein the aqueous solution includes a sugar.

10. The colloidal composition of claim 1, wherein the thermo-reversibly gelled polymer comprises partially hydrolyzed poly(vinyl)acetate.

11. The colloidal composition of claim 10, wherein the thermo-reversibly gelled polymer comprises poly(vinyl) acetate hydrolyzed to an extent greater than 80%.

12. The colloidal composition of claim 11, wherein the thermo-reversibly gelled polymer comprises poly(vinyl) acetate hydrolyzed to an extent greater than 87%.

13. The colloidal composition of claim 1 wherein the polymer is comprised of a polymer including the [vinyl alcohol] repeat unit.

14. The colloidal composition of claim 1 wherein the population of substantially monodispersed polymeric colloidal particles has an average diameter from about 50 nanometers to about 800 nanometers.

15. A product selected from the group consisting of sensor materials, optical filters, coatings, color shifting additives, paint additives, cosmetic additives, sound insulation or colloidal storage approaches comprising a colloidal composition of claim 1.

16. A method of embedding a colloidal composition within a thermo-reversibly gelled polymer comprising:
dispersing a population of colloidal particles in an aqueous solution including a polymer and a co-dispersant to form a dispersion, subjecting the dispersion to a temperature which causes the polymer to gel.

17. The method of claim 16 further comprising removing ionic species from the dispersion.

18. The method of claim 17, wherein the removing step is selected from adding ion-exchange resin or dialyzing.

19. The method of claim 16 wherein the polymer is comprised of a partially hydrolyzed poly(vinyl)acetate and the co-dispersant is selected from the group consisting of dimethylsulfoxide, glycerine, ethylene glycol, propylene glycol and triethylene glycol.

20. The method of claim 19 wherein the population of colloidal particles comprises substantially monodispersed polymeric particles in a crystalline colloidal array having an average diameter from about 30 nanometers to about 3000 nanometers, and a coefficient of variation of particle diameter of about 15% or less.

21. The method of claim 16 wherein the subjecting step includes the temperature of less than about 10 degrees Celsius.

22. The method of claim 21 wherein the subjecting step includes the temperature of less than about 0 degrees Celsius.

23. The method of claim 22 wherein the subjecting step includes the temperature of less than about −20 degrees Celsius.

24. A method of storing colloidal particles comprising
dispersing a population of colloidal particles in an aqueous solution including a polymer and a co-dispersant to form a dispersion, subjecting the dispersion to a temperature which causes the polymer to gel forming a thermo-reversibly gelled colloidal material, wherein
the population of colloidal particles comprises substantially monodispersed polymeric particles in a crystalline colloidal array having an average diameter from about 30 nanometers to about 3000 nanometers, and a coefficient of variation of particle diameter of about 15% or less and
the thermo-reversibly gelled colloidal material freezes only at temperature of less than −20 degrees Celsius.

25. A method of forming photonic crystal materials wherein the thermoreversible gelation step immobilizes the periodicity of the dielectric constant modulation and where further chemistry is utilized to modify the photonic crystal material for additional applications.
